(19) United States
(12) Patent Application Publication
(10) Pub. No.: US 2006/0144707 A1
(43) Pub. Date: Jul. 6, 2006

(54) Isolation of sperm cells from other biological materials using microfabricated devices and related methods thereof

(76) Inventors: James P Landers, Charlottesville, VA (US); Jerome P Ferrance, Charlottesville, VA (US); Katie M Horsman, Charlottesville, VA (US)

Correspondence Address: BLANK ROME LLP, 600 NEW HAMPSHIRE AVENUE, N.W., WASHINGTON, DC, 20037, US

(21) Appl. No.: 10/535,926

(22) PCT Filed: Nov. 20, 2003
(86) PCT No.: PCT/US03/37205

§ 371 Date: Dec. 9, 2005

Related U.S. Application Data
(60) Provisional application No. 60/427,734, filed on Nov. 20, 2002.
(60) Provisional application No. 60/427,734, filed on Nov. 20, 2002.

(51) Int. Cl. B01D 57/02; B01D 15/08

(52) U.S. Cl. 204/455; 210/635

(57) ABSTRACT

The present invention relates to cell separation using microfabricated devices. In particular, the present invention provides methods and devices for separation of sperm from biological materials, such as other cells and molecular species, in a cell mixture in a microfabricated device through the use of electroosmotic flow, electrophoretic mobility, pressure gradient, differential adhesion, and/or combinations thereof.

This application claims priority to Provisional Patent Application No. 60/427,734, filed Nov. 20, 2002.

### FIELD OF THE INVENTION

The present invention relates to cell separation using microfabricated devices. In particular, the present invention provides methods and devices for separation of sperm from biological materials, such as other cells and molecular species, in a cell mixture in a microfabricated device through the use of electroosmotic flow, electrophoretic mobility, pressure gradient, differential adhesion, and/or combinations thereof.

### BACKGROUND OF THE INVENTION

The use of DNA typing to verify and often convict suspects in sexual crime cases relies on the separation of the perpetrator DNA from that of the victim. The perpetrator DNA is most easily obtained from sperm cells collected on vaginal swabs, taken in the routine collection of sexual assault evidence. The majority of cells collected on such swabs are epithelial cells from the victim, however, and these cells must be separated from the sperm cells before DNA from the sperm cells can be recovered and STRs amplified for analysis by capillary electrophoresis (or other analytical methods). Effective separation of the victim's and perpetrator's DNA, combined with the ensuing preparatory/analysis steps, are time- and labor-intensive processes. At the present time, this is carried out by chemical means involving differential lysis of the cells collected on the vaginal swab. The multistep procedure begins by lysing the epithelial cells while still adsorbed to the cotton swab. During this time, the intact sperm cells (mainly heads since the tails have been degraded) are desorbed from the cotton swab, collected and then lysed for DNA extraction using a Microcon™ concentration step or other methods known in the art.

The multistep nature of this current method affords it the same disadvantages from which many conventional isolation methodologies suffer. First, the time-consuming and labor-intensive procedure translates into cost-ineffectiveness. Second, extensive sample handling presents opportunities for loss of biological material, which may be problematic if only small amounts of starting material are available. In addition, extensive sample handling increases the chance of contamination with exogenous DNA, which can complicate interpretation of the results.

One possible solution to the conventional, time-consuming differential extraction could be provided by microminiaturization of the analytical methodology in an embodiment that allowed for cell sorting to be executed rapidly and efficiently. Much progress has been made developing microchip-based analytical systems to carry out simple processes. In the early stages, a number of groups demonstrated the analytical power of microchips for carrying out fast separations (Harrison et al. Towards miniaturized electrophoresis and chemical analysis systems on silicon: an alternative to chemical sensors. Sensors and Act. B. 10:107-116, 1993; Manz, A., Graber, N., Widmer, H. M. Miniaturized Total Chemical Analysis Systems: A Novel Concept for Chemical Sensing., Sensors and Actuators, B1. 8:244-248, 1990; and Jacobson et al. Integrated Microdevice for DNA Restriction Fragment Analysis. Anal. Chem. 1996 68:720-723). Patents have also been issued for these microfluidic devices.

U.S. Pat. No. 5,486,335 to Wilding et al. discloses devices and methods for detecting the presence of a preselected analyte in a fluid sample. The invention provides a device comprising a solid substrate, typically on the order of a few millimeters thick and approximately a 0.2 to 2.0 centimeters square, microfabricated to define a sample inlet port and a microscale flow system. A sample is passed through the microfabricated device, and the restriction or blockage of flow through the flow system is detected as a positive indication of the presence of the analyte. The device may be adapted for operation in conjunction with a pump, for example, to induce flow of a sample through the flow system.

Despite the laxity in the field that fast separations are adequate, our experience with clinical diagnostics indicates that sample preparation will have to be integrated with electrophoresis in order for this technology to be fully exploited. Therefore, the present invention addresses a key sample preparation step, cell sorting, in cell analyses, especially for forensic analyses.

Other groups addressing the cell-separation problem use an antibody-based separation scheme. Eisenberg et al. (unpublished report) uses magnetic beads, to which sperm-specific antibodies are attached. There may be numerous problems associated with this approach including: clogging of the column by the large numbers of epithelial cells in a “real-world” sample, inability to integrate the cell separation with other microminiaturization analyses, expense of materials, and numerous steps still required to result in PCR-ready DNA. A reliable separation may not result using the antibody/magnetic bead approach due to extensive clogging of the column. The present invention described herein overcomes the shortfalls of the conventional procedures as well as this antibody/magnetic bead capture system. The non- or low-affinity based separation described utilizes the differing physical and biological properties of the sperm and epithelial cells to effect a separation.

Microfabricated devices have recently been developed for cell separations and transport. Kricka et al. (Applications of a microfabricated device for evaluating sperm function. Clin Chem. 39(9):1944-7, 1993) used a microfabricated device for the electrophoretic separation of live and dead sperm based upon their differences in surface charge.

U.S. Pat. Nos. 5,296,375 and 5,427,946, both to Kricka et al., discloses devices and methods similar to Wilding et al. above for clinical analysis of a sperm sample. In one embodiment, a sperm sample is applied to the inlet port, and the competitive migration of the sperm sample through the mesoscale flow channel is detected to serve as an indicator of sperm motility. In another embodiment, the substrate of the device is microfabricated with a sperm inlet port, an egg nesting chamber, and an elongate mesoscale flow channel communicating between the egg nesting chamber and the inlet port. In this embodiment, a sperm sample is applied to the inlet port, and the sperm in the sample are permitted to competitively migrate from the inlet port through the channel to the egg nesting chamber, where in vitro fertilization occurs. The devices may be used in a wide range of applications in the analysis of a sperm sample, including the analysis of sperm morphology or motility, to assess sperm binding properties, and for in vitro fertilization.

Li and Harrison (Transport, manipulation and reaction of biological cells on-chip using electrokinetic effects. Anal. Chem. 69: 1564-1568, 1997) showed the transport (not separation) and lysis of E. Coli, yeast, and canine erythrocytes in a microchip exploiting electrokinetic effects. Using electric fields of 100-600 V/cm, cells were directed from the loading reservoir to the waste or outlet reservoirs of the microdevice.

Fu et al. (A microfabricated fluorescence-activated cell sorter. Nature Biotech. 17:1109-1111, 1999; and An integrated microfabricated cell sorter. Anal Chem. 74 (11):2451-2457, 2002) developed a microfabricated fluorescence-activated cell sorter. This system requires that the sorted cells be fluorescently labeled, by means of expression of green fluorescent protein or in some other manner. This method of cell sorting requires interrogation/identification of the particle, and subsequent valving of the flow to direct the cell into the correct reservoir on the microdevice.

U.S. Pat. No. 6,193,647 to Beebe et al. discloses a microfluidic embryo handling device and method in which biological rotating of embryos is simulated. Fluid flow is used to move and position embryos without assistance of electrical stimulus or other means which may produce undesired heating of biological medium used as the fluid for transporting and position. The device provides an excellent simulation of biological conditions and may be used for culturing, sorting, testing, evaluating, fertilizing and other similar typical handling operations. No cell separation is disclosed in this patent.

Separation and identification of various bacteria have been shown by Armstrong et al. (Rapid identification of the bacterial pathogens responsible for urinary tract infections using direct injection CE. Anal. Chem. 72:4474-6, 2000; and Separating microbes in the manner of molecules: 1. Capillary electrokinetic approaches. Anal. Chem. 71, 5465-5469, 1999) using conventional capillary electrophoresis. Armstrong et al. separated and identified E. coli and Staph. Saprophyticus, which are bacterial pathogens commonly responsible for urinary tract infections, by using poly(ethylene) oxide as a sieving matrix. In 2001, Armstrong et al. used conventional capillary electrophoresis for the separation of various bacteria from yeast. The microbes were detected using laser-induced fluorescence and, therefore, required staining with a fluorescent dye. They used this separation/detection method to evaluate cell viability using a commercially-available viability stain and detecting the difference in fluorescence emission.

### SUMMARY OF THE INVENTION

The speed and efficiency of the conventional differential extraction procedure warrants improvement by the micro-miniaturization of cell sorting. A stand-alone microdevice for rapidly sorting sperm cells from epithelial cells and extracting DNA would improve DNA analysis in the crime laboratories by reducing the cost of analysis through improved speed, reduced reagent consumption, decreased technician time, reduced sample handling-induced contamination, and ease of automation. The present invention provides a novel method and device for separation of sperm and epithelial cells on a microdevice. A separation method that does not require a high affinity interaction with the cells but, instead, one that exploits electrophoretic mobility, electroosmotic flow, pressure-based flow and/or combination thereof is exploited. This present invention utilizes the differential physical and biological properties of the cells, such as their propensity for adhesion, specific gravity, cell surface charge, and size. Two important aspects of such a cell separation mechanism separation are, but not limited thereto, the magnitude of the flow, which can be controlled by a number of mechanisms, such as electrophoretic mobility, electroosmotic flow, pressure gradient (pump as well as gravity), and/or combinations thereof, as well as the surface properties of the channel walls. The present invention provides techniques for the isolation of sperm cells from biological materials, preferably other cells and molecular species, most preferably epithelial cells, for forensic applications using microfabricated devices.

In a further embodiment, the present invention is used to isolate sperm from either other cells or other biologically-derived molecular species enables sperm to be concentrated in smaller volumes. This effect could find utility with in vitro fertilization applications. Beebe et al. has shown that human eggs (oocytes) can be manipulated in microfabricated devices in processes pertinent to in vitro fertilization. The device described herein for sperm cell isolation could be utilized to enhance the concentration (number) of sperm in the collection chamber. One could envision how the presence of an oocyte in the collection chamber where an enhanced concentration of sperm are collected, might improve the efficiency of in vitro fertilization.

In a further embodiment, the present invention is used to isolate sperm from either other cells or other biologically-derived molecular species enables sperm quantitation. This could be accomplished with a number of on-line counting sperm approaches as the migrate through the microchannel to the collection reservoir. Included in these means would be optical detection using either light scattering from a laser or other focused light source, impedance spectroscopy, fluorescence detection (assuming the cells were fluorescently tagged), or some form of imaging software that was capable of counting cells based on size. This would find utility in forensic applications defining when the requisite number of sperm from the biological sample required for the analysis had been collected in the collection reservoir.

In a further embodiment, the present invention is used to isolate sperm from other cells or other biologically-derived molecular species via some flow-driven separation process presents the possibility of quantitating subpopulations of sperm from the sample. This could facilitate the evaluation of sperm that are dysfunctional with respect to fertilization ability, the separation of sperm subpopulations that are functional relative to those that are dysfunctional due to exposure to toxicants (apoptotic) or cryostorage.

### BRIEF DESCRIPTION OF THE DRAWINGS

FIG. 1 shows the size difference between sperm and epithelial cells.

FIG. 2 outlines microchannel cell separation based on cell density/adhesion differences.

FIG. 3 outlines microchannel cell separation in an electric field-driven system based upon density, proclivity for adhesion, and electrophoretic mobility. The sperm are swept with the flow to the cathodic reservoir (right).

FIG. 4 shows an alternate manifestation of the microchannel cell separation in an electric field-driven system based upon density, proclivity for adhesion, and electrophoretic mobility. In this three-reservoir system, the cell mixture is deposited in the central reservoir, and the epithelial cells and sperm cells are collected in the outside reservoirs.

FIG. 5 shows the present invention being used as part of a multi-function (multiple ‘domain’) totally-integrated system.

### DETAILED DESCRIPTION OF THE PREFERRED EMBODIMENTS

The present invention exploits physical and/or biological properties of sperm and other biological materials, such as epithelial cells, to effect a robust and reliable separation of the two cell types. Biological materials used herein includes, but is not limited to, other cells, such as epithelial cells, red blood cells, white blood cells, etc.; molecular species, such as nucleic acids (RNA and DNA), proteins, etc.; cell membranes; and organelles. Two separation approaches can be utilized to invoke separation of cells, with a main focus on the separation of sperm from other cells for forensic analysis where both the sperm and the other cells can be important in the forensic process. The first mode amenable to a microfabricated device is a separation driven by an electric field—this inherently involves both an electrophoretic component (mobility of cells based on size and their surface charge) and a flow component in the form of electroosmotic flow (EOF—the flow that results from the presence of ions in glass channel). The second type, one that does not invoke the use of electric fields but is based solely on flow, can be driven by a number means including gravity-driven (siphoning), hydrostatic pressure (or vacuum)-driven flow, or centrifugal driven flow.

I. Cell Separation Exploiting Electrokinetic Phenomena

In microchip electrophoresis, analytes are acted upon by two forces, intrinsic electrophoretic mobility (μₑₚ), governed by the charge-to-size ratio of the analyte, and EOF, generated by charge on the microchannel surface. For cell separations, these forces can be employed together, or EOF can be reduced (or close to zero), with the electrophoretic mobilities providing the main governing force for the separation. Consequently, three scenarios emerge where separation is driven by 1) electrokinetic phenomena specific to the cells themselves; 2) a combination of electrokinetic phenomena specific to the cells and the EOF; and 3) the low volume, plug-type flow resulting from EOF. These are addressed individually below.

A. Separation Based Solely on Cell Electrophoresis

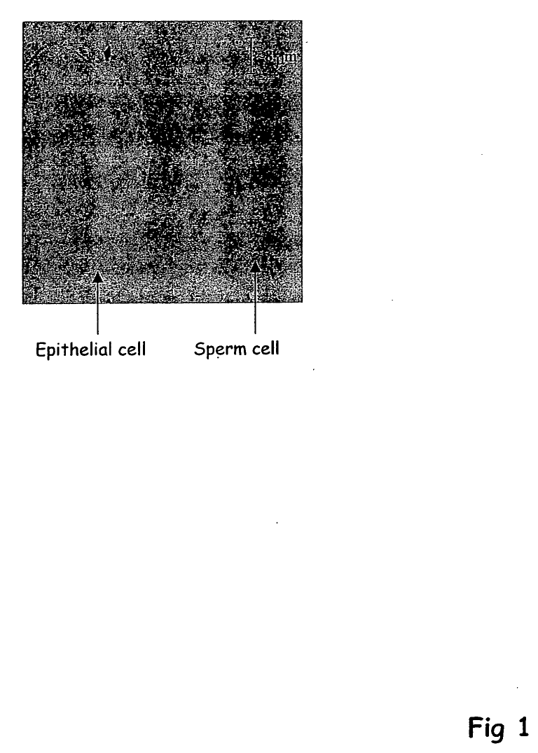

The simplest scenario in microchips, one where the chip surface was treated to negate the EOF, cell electrophoretic mobility becomes the dominant separation force. This has already been demonstrated in the literature (Kricka et al., 1993) by the separation of live and dead sperm in an electric field, which is likely due to differences in the cell surface charge, however, the role of EOF in this separation cannot be ruled out. For sperm and epithelial cells, the significant size difference (4-5 μm vs 50 μm) presents a scenario where there is likely to be significant differences in charge-to-size ratio, and this may be exploited for the sake of separation (FIG. 1). In addition, the surface charge of the cells can be varied with pH, solution composition, and ionic strength of the separation buffer. This allows altering the surface charges in the electrophoretic-based separation scheme to optimize the separation speed and efficiency.

An electrophoretically-driven system is attractive because, in addition to separation of the cells, there is a cellular concentrating effect. Therefore, the buffer volume used to desorb the biological material from the swab would have minimal impact on downstream sample preparation or analytical processes where volume limitations may exist. In addition, any free DNA in the biological material is not captured in the sperm fraction.

B. Separation Based on Cell Electrophoresis and EOF

In addition to exploiting cell electrophoretic mobility, a significant EOF provides a flow bulk component to the separation and, under the appropriate circumstances, can enhance the separation. Under conditions with a reasonable EOF, the differential movement of sperm and epithelial cells exists under low electric field strengths (about 5-1000 V/cm, preferably about 25-300 V/cm, most preferably about 75-100 V/cm). Sperm migrate toward the cathode, while epithelial cells have an opposite mobility (to the anode). However, in the same way that the surface charge of the cells can be altered by the pH, solution composition, and ionic strength of the separation buffer, so can the EOF. A high solution ionic strength reduces the charge on the microchannel surface (the zeta potential) and, hence, reduces the EOF. Reducing or even eliminating the charge on the microchannel surface by covalent, dynamic or absorptive coating can similarly reduce or minimize EOF. A similar effect can be achieved by reducing the solution pH, but this is less attractive with cells that will need to be maintained in the biological pH range. Consequently a number of approaches can be used to optimize the EOF that allows for optimal separation of the analytes involved, in this particular case, different biological materials, specifically, sperm and epithelial cells.

C. Separation Based Solely on Electric Field-Driven Flow (EOF)

See EOF section below.

II. Flow-Based Separations

A critical aspect of this mechanism is the magnitude of the flow used for the separation. A flow that is low in magnitude (about 0.1-1000 μL/hr, preferably about 0.3-10 μL/hr, and most preferably about 0.6 μL/hr) and reproducibly-controlled flow is utilized for these separations and can be achieved with a number of approaches.

A. EOF

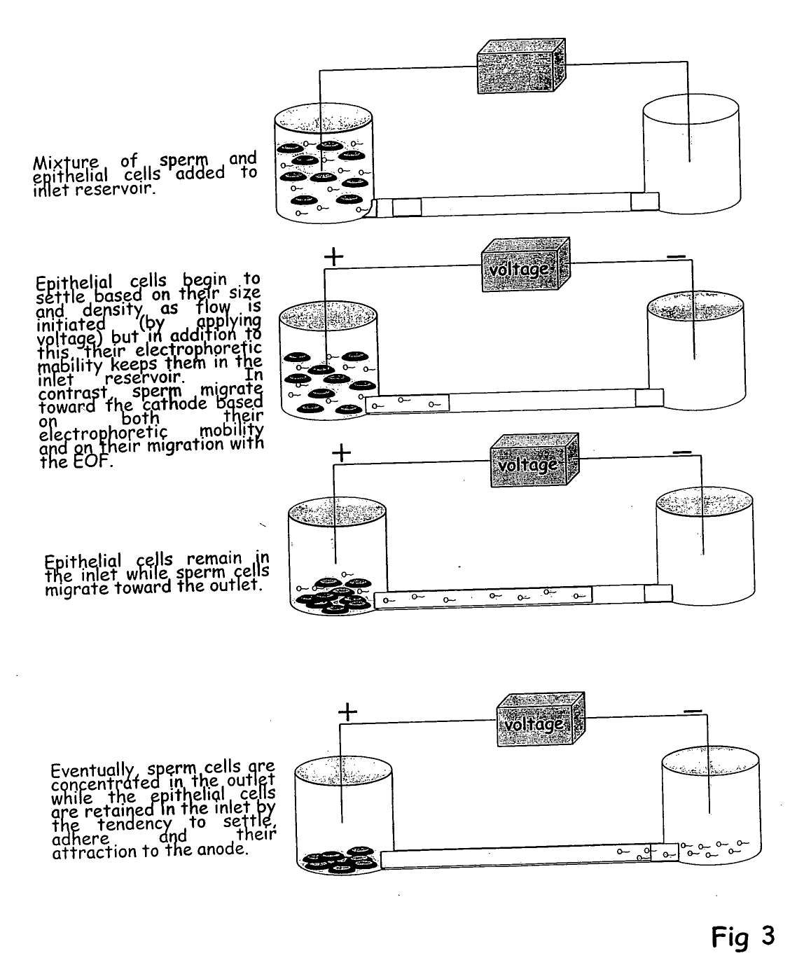

The low magnitude, plug-type flow associated with EOF (no turbulence) is ideal for separating cells based on physical characteristics. Modification of the silica surface charge allows control of EOF and provides a support for electrostatic interactions that can further increase the cell separation efficiency. Under low electric field strength (e.g., ˜33V per cm of microchannel), we have observed the differential movement of sperm and epithelial cells in phosphate-buffered saline (pH 7.4)—the sperm cells migrate to the cathode and epithelial cells migrated to the anode. Hence, placement of a mixture of sperm and epithelial cells in a reservoir on a microdevice, and proper placement of electrodes results in the separation of sperm cells from the mixture into another reservoir containing the cathode. An applied field is used to direct the sperm cells into the desired reservoir on the microdevice (FIG. 3). The migration of epithelial cells to the anode is due to their negative surface charge. Sperm cells also have an overall negative surface charge, but the sperm migrate toward the cathode because the magnitude of electroosmotic flow is greater than the magnitude of the electrophoretic mobility of the sperm cells. In a separation based upon EOF flow, we can also take advantage of the other mechanisms of separation described herein such as density differences, proclivity for adhesion to the microchannel surface as well as to other cells, as well as the electrophoretic mobility differences. In this manner, the selectivity and efficiency of separation can be enhanced.

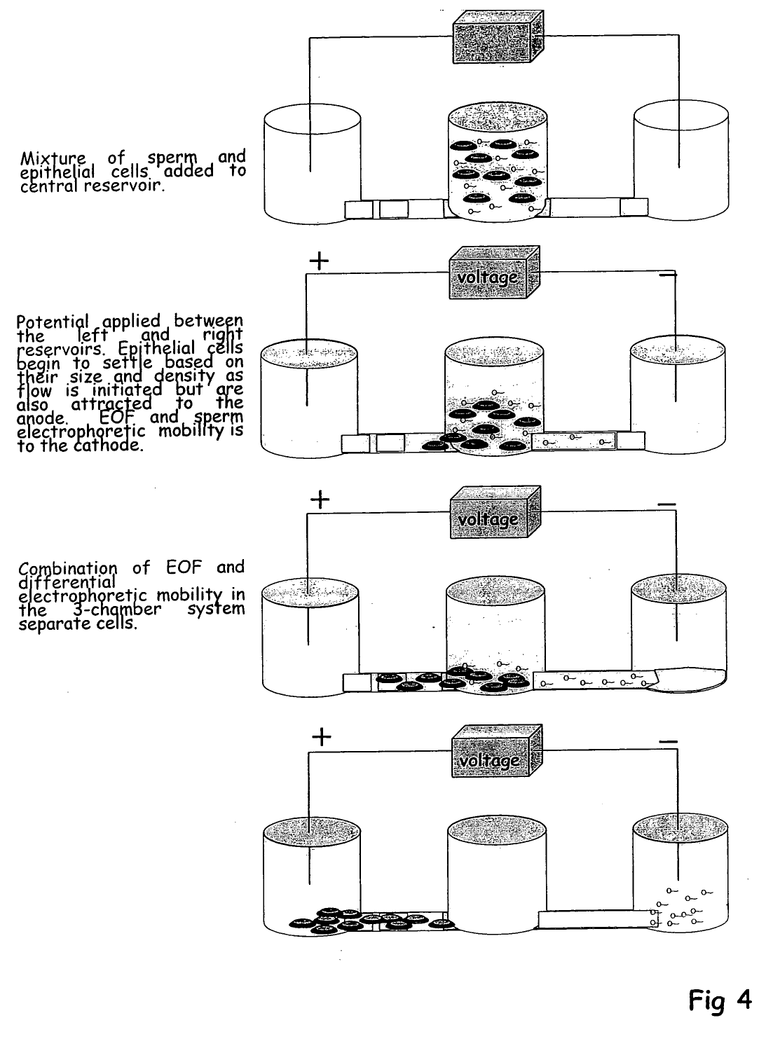

In an alternate embodiment of this concept, the mixture reservoir can be placed between two reservoirs connected in a linear fashion by a microchannel etched into the glass (FIG. 4). By placing electrodes in these two outside reservoirs, the mixture in the center can be separated and the two cell types and/or biological materials collected in the separate outside reservoirs. It should be noted that, in either manifestation, the use of a separation using electrokinetic effects has the added benefit in that any DNA in the cell mixture from cells lysed prior to the separation is attracted to the anode and, thus, is separated from the sperm cell fraction. This is particularly important in forensic applications.

B. Gravity-Driven Flow

Gravity-driven flow (siphoning) can also provide a low magnitude flow that can be controlled with some accuracy and, hence, could be employed to differentially move the cells in microchannels. Under these conditions, the effect of gravity not only drives the flow of fluid from one reservoir to the other, but density differences in the cells in a mixture can be exploited, in which the epithelial cells settle more readily than sperm cells. For example, in the case of sperm and epithelial cells, approximately 5 minutes is sufficient to allow the epithelial cells to ‘settle’ to the bottom of the reservoir/channel before flow is induced. Flow is then induced by mismatched liquid heights in connecting reservoirs. The data shows that the fluid flow rate remains constant at an acceptable magnitude for at least 10 minutes, allowing adequate time for a cell separation where sperm were observed leaving the mixture reservoir at a rate of approximately 5 sperm/sec.

C. Pressure (or Vacuum)-Driven Flow

More reproducible and controllable flow rates can be generated in a pressure-driven system employing the appropriate volume syringes and pumps. This uses the same mechanism of separation as the gravity-driven flow, but would provide greater opportunity for automation due to the external control of the flow rate. Clearly what was accomplished with gravity-driven flow could be achieved with this system but in a much more automatable manner.

III. Combined Separation

Techniques discussed above are can be used alone or in combination. Various combinations are appropriate for the present invention. A successful separation typically utilizes both flow and electrokinetic separations. The following are non-limiting examples of combined separations that are appropriate for the present invention: 1) separation utilizing electrokinetic phenomena and pressure-driven flow; 2) separation utilizing pressure-driven flow and EOF; and 3) separation utilizing electrokinetic phenomena, pressure-driven flow, and EOF. Further, gravity, vacuum-driven and centrifugally-driven flow can easily substitute for the pressure-driven flow discussed in the possible combined separation regimes.

IV. Other Considerations for Isolation of Sperm Cells from a Biological Mixture

A. Surface Area-to-Volume Considerations

There are a number of channel design modifications that result in an increased surface-to-volume ratio, which we believe will also increase the separation efficiency.

These include placing microfabricated posts in the separation channel. In this way, the posts (separated by approximately 8 μm) act as a physical filter allowing sperm cells to freely flow through the barriers, while the epithelial cells are too large (Chen et al., 1998). They utilized filters of varying size (5-35 μm) to separate the cells (based solely upon cell size) prior to DNA extraction of each fraction. Wilding et al. (1998) used 7 μm-spaced barriers in microchannels to effect a size-based separation of white and red blood cells. An s-curve channel shape will create a similar increase in surface-to-volume ratio without the incorporation of posts. An alternate manifestation of this cell separation invention involves the use of increased surface-to-volume ratios in conjunction with the electroosmotic, pressure-driven and gravity-flow in the microchannel to optimize the separation efficiency resulting from various physical and/or biological characteristics of the cells such as proclivity for adhesion, size, and density.

B. Exploiting Differential Adhesion

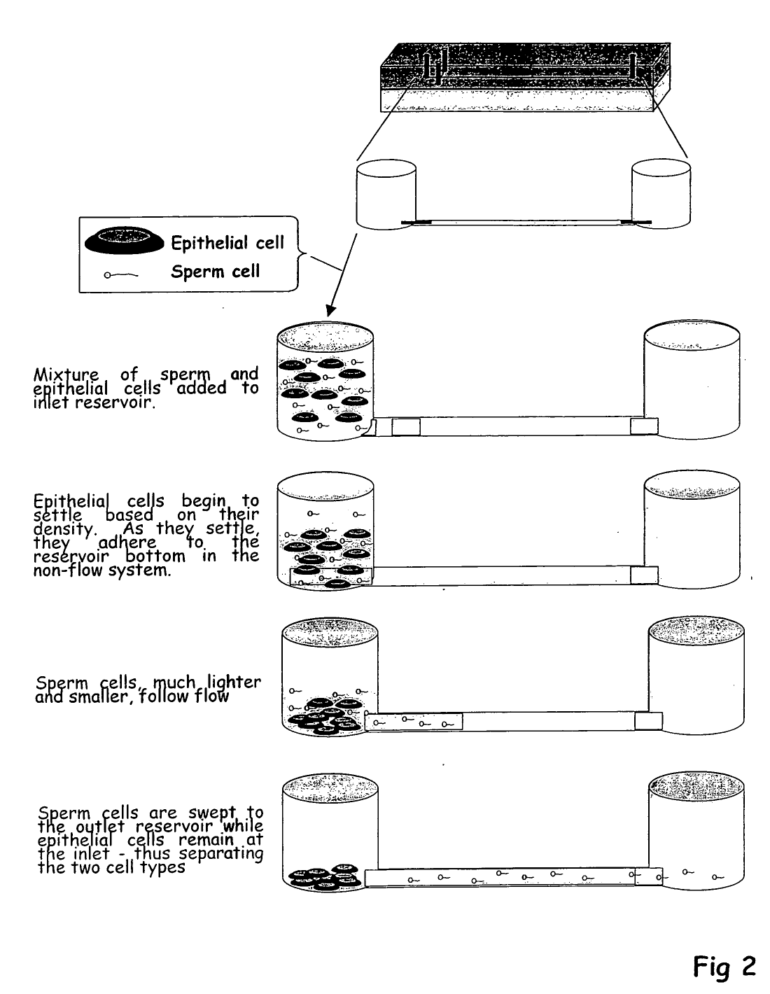

An inherent biological characteristic of white blood cells (WBCs) is their ability to adhere to surfaces in biological systems. Wilding et al. (1998) exploited this, trapping WBCs using a series of weir-type filters, with efficient trapping relying on increasing the surface-to-volume ratio and enhancing the opportunity for WBCs to bind to the channel surface. A similar phenomenon is exploited in the current invention where sperm and epithelial cell mixtures may be separated as the epithelial cells adhere to each other and to glass microchannel surfaces to a much greater extent than do sperm cells. This results from the larger surface/contact area of the typically flat epithelial cells. In addition to exploiting the high proclivity for adhesion of epithelial cells (to the glass surface and to other epithelial cells) in comparison to sperm, the cell separation shown in FIG. 2 is also based upon their size and density. The sperm cells, smaller and less dense, are swept by the fluid movement into the channel and to the outlet reservoir.

C. Capture of Free DNA and Other Non-sperm Components

The sperm separation method of the present invention may be optimized to effectively remove other non-sperm components of the mixture that may be problematic to the user. These components can include, but are not limited to, DNA and other cells such as white blood cells, red blood cells bacteria and yeast. DNA can be effectively prevented from contaminating the sperm cell fraction with the use of a positively-charged microchannel coating combined with the appropriate buffer (possessing the appropriate ionic strength, pH, etc.), or with the use of a buffer (possessing the appropriate ionic strength, pH, etc.) needed for use of a bare (untreated) microchannel wall. In a similar manner, a positive, neutral, or negative microchannel coating (covalent or dynamic) may be needed in conjunction with the appropriate buffer (ionic strength, pH, etc.) to optimize the separation of sperm from other non-sperm components. In addition, the ionic strength, pH, concentration, and viscosity of the electrolyte solution may be optimized by the addition of other modifiers (e.g., detergent) to optimize the removal of unwanted cellular, protein, nucleic acid or low molecular weight components that may interfere with analysis.

V. Microfabricated Devices

Microfabricated or microfluidic devices are used to perform the separation of the present invention. “Microfabricated” or “microfluidic,” as used herein, refers to a system or device having fluidic conduits or microchannels that are generally fabricated at the micron to submicron scale, e.g., typically having at least one cross-sectional dimension in the range of from about 0.1 μm to about 500 μm. The microfluidic system of the invention is fabricated from materials that are compatible with the conditions present in the particular experiment of interest. Such conditions include, but are not limited to, pH, temperature, ionic concentration, pressure, and application of electrical fields. The materials of the device are also chosen for their inertness to components of the experiment to be carried out in the device. Such materials include, but are not limited to, glass, quartz, silicon, and polymeric substrates, e.g., plastics, depending on the intended application.

The device generally comprises a solid substrate, typically on the order of a few millimeters thick and approximately 0.2 to 12.0 centimeters square, microfabricated to define at least one inlet reservoir, at least one outlet reservoir, and a microchannel flow system, preferably a network of flow channels, extending from the at least one inlet reservoir to the at least one outlet reservoir. In the embodiment depicted in FIGS. 2 and 3, a sperm containing biological sample is applied to the inlet reservoir; and the sperm moves, under various force(s) discussed above, from the inlet reservoir through the microchannel to the outlet reservoir.

In the embodiment depicted in FIG. 4, the device comprises at least three reservoirs and at least two channels. The inlet reservoir is connected to a first outlet reservoir by a first channel, and is connected to a second outlet reservoir by a second channel. A sperm containing biological sample is applied to the inlet reservoir; and the sperm moves, by EOF and electrophoretic mobility, from the inlet reservoir through the microchannel to the first outlet reservoir, while the other cells, preferably epithelial cells, moves from the inlet reservoir to the second outlet reservoir.

Although the drawings show only one separation apparatus, multiple separations may be accomplished on a single chip. These multiplexed separations can be done in parallel or at different times, depending on the load requirements of the user. Further, the main separation channel can intersect and connect with other channels. This is important, for example, for diluting the sample, adjusting the pH of the sample, adding reactants to the sample, coating the channel, etc. For the case of adjusting the pH, the intersection can be used to inject acid and/or base to the solution flowing in the main separation channel. In doing so, the pH of the solution flowing in the main separation channel can be controlled and varied along the length of the channel.

Analytical devices having microfabricated flow systems can be designed and fabricated in large quantities from a solid substrate material. They are preferably easy to sterilize. Silica and silicon are the preferred substrate materials because of the well-developed technology permitting its precise and efficient fabrication, but other materials may be used including cast or molded polymers including polytetrafluoroethylenes and polydimethylsiloxane (PDMS). The sample inlet and other reservoirs, the microfabricated flow system, including the flow channel(s) and other functional elements, may be fabricated inexpensively in large quantities from a silicon substrate by any of a variety of micromachining methods known to those skilled in the art. The micromachining methods available include film deposition processes such as spin coating and chemical vapor deposition, laser fabrication or photolithographic techniques such as UV or X-ray processes, or etching methods which may be performed by either wet chemical processes or plasma processes.

Flow channels of varying widths, depths, and shape can be fabricated with microfluidic dimensions for use in sperm separation. The silica substrate containing a fabricated microchannel may be covered and sealed, e.g., thermally bonded, with a thin glass cover. Other clear or opaque cover materials may be used. Alternatively, two silica substrates can be sandwiched, or a silicon substrate can be sandwiched between two glass covers. The use of a transparent cover results in a window which facilitates dynamic viewing of the channel contents, and allows optical probing of the micro-flow system either visually, by machine, and/or by laser interrogation. Other fabrication approaches can also be used.

The capacity of the devices is very small and therefore the amount of sample fluid required for an analysis is low. For example, in a 3 cm×3 cm silicon substrate, having on its surface an array of 50 channels which are 120 μm wide×40 μm deep×2 cm (2×10⁴ μm) long, the volume of each groove is 0.096 μL and the total volume of the 50 grooves is 4.8 μL. The low volume of the microfabricated flow systems allows assays to be performed on very small amounts of a liquid sample (<5 μL). The devices may be microfabricated with microliter volumes, or alternatively nanoliter volumes or less, which advantageously limits the amount of sample, buffer or other fluids required for an analysis. Thus, an important consequence and advantage of employing flow channels having microscale dimensions is that very small scale analyses can be performed.

To provide appropriate electric fields, the system generally includes a voltage controller that is capable of applying selectable voltage levels, sequentially or, more typically, simultaneously, to each of the reservoirs, including ground. Such a voltage controller is implemented using multiple voltage dividers and multiple relays to obtain the selectable voltage levels. Alternatively, multiple independent voltage sources are used. The voltage controller is electrically connected to each of the reservoirs via an electrode positioned or fabricated within each of the plurality of reservoirs. In one embodiment, multiple electrodes are positioned to provide for switching of the electric field direction in a microchannel, thereby causing the analytes to travel a longer distance than the physical length of the microchannel. Use of electrokinetic transport to control material movement in interconnected channel structures was described, e.g., in WO 96/04547 to Ramsey, which is incorporated by reference.

Modulating voltages are concomitantly applied to the various reservoirs to affect a desired fluid flow characteristic, e.g., continuous or discontinuous (e.g., a regularly pulsed field causing the sample to oscillate direction of travel) flow of labeled components toward a waste reservoir. Particularly, modulation of the voltages applied at the various reservoirs can move and direct fluid flow through the interconnected channel structure of the device.

Another way to control flow rates is through creation of a pressure differential. For example, in a simple passive aspect, a cell suspension is deposited in a reservoir or well at one end of the channel, and at sufficient volume or depth, that the cell suspension creates a hydrostatic pressure differential along the length of the channel, e.g., by virtue of its having greater depth than a well at an opposite terminus of the channel. Typically, the reservoir volume is quite large in comparison to the volume or flow through rate of the channel, i.e., 1 μL reservoirs or larger as compared to a 100 μm channel cross section. Another pressure based system is one that displaces fluid in the microfluidic channel using, e.g., a probe, piston, pressure diaphragm, or any other source capable of generating a positive or negative pressure.

Alternatively, a pressure differential is applied across the length of the channel. For example, a pressure source is optionally applied to one end of the channel, and the applied pressure forces the material through the channel. For example, pressure applied at the inlet reservoir would force the cell mixture contained therein through the microchannel, and into the outlet reservoir. The pressure is optionally pneumatic, e.g., a pressurized gas or liquid, or alternatively a positive displacement mechanism, i.e., a plunger fitted into a material reservoir, for forcing the material along through the channel. Pressure can, of course, also be due to electrokinetic force, thermal expansion, or a variety of other methods and devices.

Alternatively, a vacuum source (i.e., a negative pressure source) is applied to a reservoir at the opposite end of the channel to draw the suspension through the channel. A vacuum source can be placed in the outlet reservoir to draw a cell suspension from the inlet reservoir. Pressure or vacuum sources are optionally supplied external to the device or system, e.g., external vacuum or pressure pumps sealably fitted to the inlet or outlet of the channel, or they are internal to the device, e.g., microfabricated pumps integrated into the device and operably linked to the channel, such as those disclosed in WO 97/02357 to Anderson et al., which is incorporated herein by reference.

Alternatively, flow in this system could be established by centrifugal forces generated by spinning microdevices around a central axis. The channels in the microdevices would be situated at least partly radially outward from the central axis with the inlet reservoir closer to the central axis than the outlet reservoir. Spinning instrumentation (e.g. centrifuge) external to the microdevice would be used to generate the required rotational motion. Flow rates through the microchannels would be controlled by changing the speed of the rotation, the distance from the central axis, or both.

The microchip-based cell separator can be designed as a mono-tasking stand-alone unit that serves a single function—cell separation. This would be consistent with the above discussion. With this system, cells extracted or desorbed from the sampling instrument, such as cotton applicator, would be added to the inlet reservoir in the appropriate volume where application of the appropriate forces would used to facilitate the cell separation. The separated material, sperm and other cells, would be removed from their respective reservoirs for subsequent analysis.

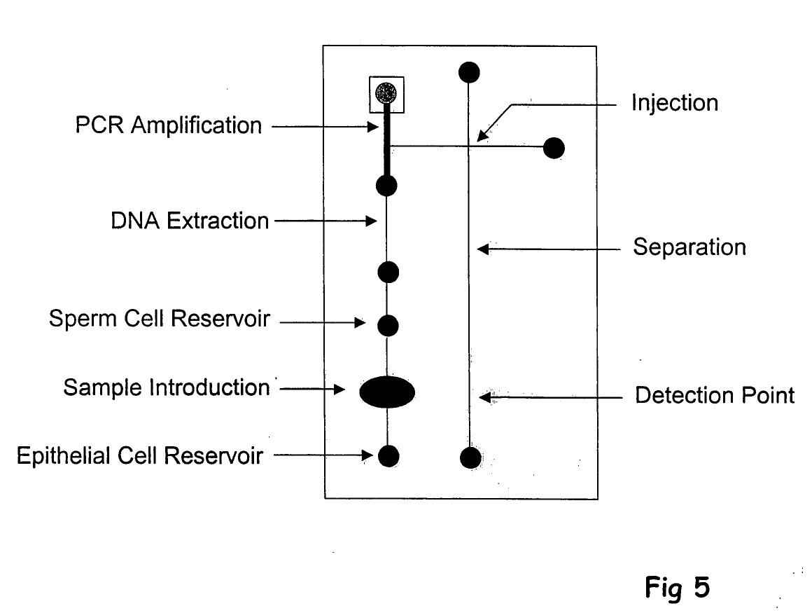

The microchip-based cell separator can also be envisioned as part of a multi-function (multiple ‘domain’) totally-integrated system that caries out numerous processes, either simultaneously or serially (FIG. 5). This involves the cell separator as only one of many domains in an integrated system that could provide ‘sample in/answer out’ capability. This arrangement has the cell separation domain receiving a cell mixture from ‘upstream’ processing, via fluidic transfer, from a cell extraction (e.g., elution and/or desorption) domain where the cell mixture is obtained and removed from the original sampling instrument. Following separation of the sperms from other cells, the sperms and other cells are transferred for downstream processing which involves fluidic transfer to one of two subsequent domains for processing. In one embodiment, the sperms and/or others cells are transferred to a ‘DNA extraction’ domain and then to the ‘PCR’ domain for select target DNA amplification prior to STR typing. Alternatively, the sperms and/or other cells would be transferred directly to the PCR domain for select target DNA amplification.

Such integrated system can be carried out with a ‘valveless’ microchip where control of fluidic movement is carried out with pumps or electrokinetically. Alternatively, the use of a valved system can be invoked. This integrated approach allows for insulation of each of the domains more effectively and minimizes leakage or contamination of reagents from one domain to another.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A method for isolating sperm cells comprising the steps of a) providing a biological sample containing sperm cells;
b) providing a at least a first reservoir and a second reservoir, and a microchannel connecting the first and second reservoirs;
c) placing the sample into the first reservoirs;
d) applying a separation means between the first and second reservoirs to separate the sperm cells from other biological materials; and
e) collecting the sperm cells, substantially free of the other biological materials, in the second reservoir.

2. The method of claim 1, wherein the separation means is an electric field.

3. The method of claim 1, wherein a potential is placed between the first and second reservoirs.

4. The method of claim 1, wherein the separation means is electroosmotic flow.

5. The method of claim 1, wherein the separation means is a pressure-induced flow.

6. The method of claim 1, wherein the other biological materials are selected from the group consisting of epithelial cells, white blood cells, red blood cells, bateria, yeasts, proteins, RNAs, DNAs, and combinations thereof.

7. The method of claim 1, wherein the separation means is electroosmotic flow and an electric field.

8. The method of claim 7, wherein a potential is placed between the first and second reservoirs.

9. The method of claim 1, wherein the separation means is electroosmotic flow and pressure-induced flow.

10. The method of claim 9, wherein the pressure-induced flow is generated by gravity.

11. The method of claim 9, wherein the pressure-induced flow is generated by a pump.

12. The method of claim 9, wherein the pressure-induced flow is generated by a vacuum.

13. The method of claim 9, wherein the pressure-induced flow is generated by rotational motion.

14. The method of claim 1, further comprising a third reservoir connecting to the first reservoir via a second microchannel.

15. The method of claim 14, wherein a potential is applied between the second and the third reservoir.

16. The method of claim 1, wherein the separation means is electroosmotic flow, electric field, and pressure-induced flow.

17. The method of claim 16, wherein the pressure-induced flow is generated by gravity.

18. The method of claim 16, wherein the pressure-induced flow is generated by a pump.

19. The method of claim 16, wherein the pressure-induced flow is generated by a vacuum.

20. The method of claim 16, wherein the pressure-induced flow is generated by rotational motion.

21. The method of claim 1, further comprising a third reservoir connecting to the first reservoir via a second microchannel.

22. The method of claim 21, wherein a potential is applied between the second and the third reservoir.

23. The method of claim 21, wherein the other biological materials migrate from the first reservoir to the third reservoir and the sperm cells migrate from the first reservoir to the second reservoir.

24. The method of claim 21, wherein the other biological materials are selected from the group consisting of epithelial cells, white blood cells, red blood cells, bateria, yeasts, proteins, RNAs, DNAs, and combinations thereof.

25. The method of claim 1, wherein the separation means is pressure-induced flow and an electric field.

24. The method of claim 1, wherein the biological sample comes from a vaginal swab.

25. The method of claim 1, wherein the other biological materials are further analyzed.

26. The method of claim 1, wherein the sperm cells are further analyzed.

27. The method of claim 1, wherein at least one valve is present in the microchannel for flow-control.

28. The method of claim 1, wherein the sperm cells collected in the second reservoir is concentrated.
